(19) United States
(12) Patent Application Publication
(10) Pub. No.: US 2008/0219918 A1
(43) Pub. Date: Sep. 11, 2008

(54) CATALYST FOR FUEL REFORMING AND METHOD OF PRODUCING HYDROGEN USING THE SAME

(75) Inventors: Doo-hwan Lee, Suwon-si (KR); Yulia Potapova, Yongin-si (KR); Soon-ho Kim, Seoul (KR); Hyun-chul Lee, Yongin-si (KR); Kang-hee Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/855,543

(22) Filed: Sep. 14, 2007

(30) Foreign Application Priority Data
Dec. 18, 2006 (KR) 2006-129659

(51) Int. Cl. C01B 3/02; B01J 23/10; B01J 23/02; B01J 23/22; B01J 23/26; B01J 23/30; B01J 23/28; B01J 23/58; B01J 23/63; B01J 23/648; B01J 23/652; B01J 23/42; B01J 23/44; B01J 23/46

(52) U.S. Cl. 423/648.1; 502/312; 502/313; 502/325; 502/339; 502/309; 502/248; 502/255; 502/257; 502/254; 502/262; 502/304; 502/263; 502/332; 502/333; 502/334; 502/306; 502/243; 502/308; 502/250; 502/261; 502/328; 502/330; 502/252; 502/300; 502/302; 502/340; 502/344

(57) ABSTRACT

A catalyst for fuel reforming including a metal catalyst that includes at least one active component A selected from the group consisting of Pt, Pd, Ir, Rh and Ru; and an active component B that is at least one metal selected from the group consisting of Mo, V, W, Cr, Re, Co, Ce and Fe, oxides thereof, alloys thereof, or mixtures thereof, and a carrier impregnated with the metal catalyst, and a method of producing hydrogen by performing a fuel reforming reaction using the catalyst for fuel reforming. The catalyst for fuel reforming has excellent catalytic activity at a low temperature and improved hydrogen purity. Therefore, when the catalyst for fuel reforming is used, high-purity hydrogen, which can be used as a fuel of a fuel cell, can be produced with high purity.

### CROSS-REFERENCE TO RELATED PATENT APPLICATIONS

This application claims the benefit of Korean Patent Application No. 2006-129659, filed Dec. 18, 2006, in the Korean Intellectual Property Office, the disclosure of which is incorporated herein in its entirety by reference.

### BACKGROUND OF THE INVENTION

1. Field of the Invention

Aspects of the present invention relate to a catalyst for fuel reformation and a method of producing hydrogen using the same, and more particularly, to a catalyst for fuel reformation that produces high concentration hydrogen by low temperature, liquid phase reformation of a fuel without requiring an additional reactor to remove CO, and that has improved activity, heat transfer properties, and material transfer properties, and a method of producing hydrogen using the same.

2. Description of the Related Art

Fuel cells are electricity generation systems that directly convert the chemical energy of hydrogen and oxygen to electrical energy. Fuel cell systems comprise a stack, a fuel processor (FP), a fuel tank, a fuel pump, and the like. The stack is a main body of a fuel cell and comprises several to several tens of unit cells, each of which include a membrane electrode assembly (MEA) and a separator (or bipolar plate). The fuel pump supplies fuel from the fuel tank to the fuel processor. The fuel processor produces hydrogen by reforming and purifying the fuel and supplies the resultant hydrogen to the stack. The stack receives the hydrogen and generates electrical energy by electrochemically reacting the hydrogen with oxygen.

In general, a fuel processor for producing hydrogen from hydrocarbons requires a desulfurization process, a reforming process, and a CO removing process. The CO removing process includes a high temperature shift reaction, a low temperature shift reaction, and a preferential CO oxidation (PROX) reaction.

A reformer reforms hydrocarbon fuel, such as methane, using a reforming catalyst. However, the reforming process requires that the reformer operate at a high temperature, such as 600° C. or more. Further, the reforming process requires various reactors such as a water-gas shift (WGS) reactor, a preferential CO oxidation (PROX) reactor, a methanation reactor, or the like, in order to remove CO produced from the reforming process. Therefore, when hydrocarbons are used as a fuel, the configuration and operation of the reactors are difficult to implement. Additionally, as a high temperature reaction is needed, operating speed is limited, and heat and energy management are less efficient.

To address these and/or other problems, a method of using oxygenated hydrocarbons, such as methanol, or the like, as a fuel has been proposed. A reforming catalyst of the oxygenated hydrocarbon is generally a catalyst comprising Cu, Zn, and Al, or the like. U.S. Pat. No. 6,436,354 discloses a method of using a metal, such as nickel, cobalt, palladium, rhodium, or ruthenium, as a reforming catalyst to produce hydrogen for a fuel cell. However, the reforming reactivity and hydrogen purity of a fuel gas produced in this way are not satisfactory, and thus there is still a need for improvement.

### SUMMARY OF THE INVENTION

Aspects of the present invention provide a catalyst for fuel reformation that has improved reforming reactivity and hydrogen purity at a low operating temperature, and a method of producing hydrogen using the same.

According to an aspect of the present invention, there is provided a catalyst for fuel reformation comprising a metal catalyst that includes at least one active component A selected from the group consisting of platinum (Pt), palladium (Pd), iridium (Ir), rhodium (Rh), and ruthenium (Ru); and an active component B that is at least one metal selected from the group consisting of molybdenum (Mo), vanadium (V), tungsten (W), chromium (Cr), rhenium (Re), cobalt (Co), cerium (Ce) and iron (Fe), oxides thereof, alloys thereof, or mixtures thereof, and a carrier impregnated by the metal catalyst

According to another aspect of the present invention, there is provided a method of producing hydrogen using a fuel reforming reaction performed by reacting a fuel with the catalyst for fuel reformation.

According to another aspect of the present invention, there is provided a catalyst for producing hydrogen from a fuel including a metal catalyst that includes an active component A, the active component A being a transition metal having a Pauling electronegativity of 2.20 to 2.28; and an active component B, the active component B being a transition metal, a lanthanide, or an actinide having a Pauling electronegativity less than the Pauling electronegativity of the active component A; and a carrier impregnated by the metal catalyst. The catalyst may further include an active component C, the active component C being an alkali metal or an alkaline earth metal.

According to another aspect of the present invention, there is provided a method for producing hydrogen including providing a fuel to a reformer comprising a metal catalyst wherein the reformer operates at a temperature between 60 and 250° C. to produce hydrogen having less than 0.5 mol % of CO.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a flowchart illustrating a method of preparing a catalyst for fuel reformation comprising Pt and Mo as a metal catalyst and a carrier according to an example embodiment of the present invention;

FIG. 1B is a flowchart illustrating a method of preparing a catalyst for fuel reformation comprising Pt, Mo oxide, and K as a metal catalyst and a carrier according to an example embodiment of the present invention; and

FIG. 2 is a flowchart illustrating a method of preparing a catalyst for fuel reformation comprising Pt and Mo as a metal catalyst and YSZ according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. As used below, reformation and reforming are used interchangeably to describe the same processes.

Aspects of the present invention provide a catalyst for fuel reformation that is composed of a metal catalyst comprising at least one active component A selected from the group consisting of Pt, Pd, Ir, Rh, and Ru; and an active component B that is at least one metal selected from the group consisting of Mo, V, W, Cr, Re, Co, Ce and Fe, at least one oxide of the metal selected from the group consisting of Mo, V, W, Cr, Re, Co, Ce and Fe, alloys thereof or mixtures thereof, and a carrier impregnated by the metal catalyst. Further, metal catalyst may include an active component A, the active component A being a transition metal having a Pauling electronegativity of 2.20 to 2.28; and an active component B, the active component B being a transition metal, a lanthanide, or an actinide having a Pauling electronegativity less than the Pauling electronegativity of the active component A.

The amount of the active component B may be preferably 0.1-20 parts by weight based on 1 part by weight of the active component A, and more preferably 0.3-10 parts by weight. When the amount of the active component B is less than 0.1 parts by weight based on 1 part by weight of the active component A, the amount of the active component B is so small that the effect of the contribution of the active component B to the reforming reaction is reduced. When the amount of the active component B is greater than 20 parts by weight based on 1 part by weight of the active component A, the active component B is in excess, and the effect of the contribution of the active component B to the reforming reaction with respect to the amount used is reduced.

The carrier is a metal oxide having a surface area in the range of 10-1,500 m² per gram and may be at least one selected from the group consisting of Al₂O₃, TiO₂, ZrO₂, SiO₂, yttria stabilized zirconia (YSZ), and Al₂O₃—SiO₂. The amount of the carrier may be 50-99 parts by weight based on 100 parts by weight of the total weight of the catalyst for fuel reforming.

In the metal catalyst according to aspects of the present invention, the amount of the active component A may be 0.1-30 parts by weight based on 100 parts by weight of the total weight of the catalyst for fuel reforming. When the amount of the active component A is less than 0.1 parts by weight based on 100 parts by weight of the total weight of the catalyst for fuel reforming, the amount is so small that the effect of its contribution to the reforming reaction is reduced. When the amount of the active component A is greater than 30 parts by weight based on 100 parts by weight of the total weight of the catalyst for fuel reforming, the active component A is in excess, and the distribution of the active component A in the carrier is not easily controlled. Accordingly, when the amount of the active component A is greater than 30 parts by weight based on 100 parts by weight of the total weight of the catalyst for fuel reforming, the effect of the contribution of the active component A to a reforming reaction is reduced.

The metal catalyst may further comprise at least one active component C selected from an alkali metal and an alkaline earth metal in addition to the active component A and active component B described above. The active component C can be at least one selected from the group consisting of Li, Na, K, Rb, Cs, Ca, Mg, and Ba. When the metal catalyst is prepared by adding the active component C, the reforming reactivity of the fuel is increased.

The amount of the active component C may be 0.01-10 parts by weight based on 1 part by weight of the active component A. When the amount of the active component C is less than 0.01 parts by weight based on 1 part by weight of the active component A, the effect of the contribution of the active component C to the reforming reaction is reduced. When the amount of the active component C is greater than 10 parts by weight based on 1 part by weight of the active component A, the effect of the contribution of the active component C to a reforming reaction is reduced.

The catalyst for fuel reforming may be a system comprising Pt and at least one selected from molybdenum and molybdenum oxide as the metal catalyst, and a TiO₂ carrier; a system comprising Pt and at least one selected from molybdenum and molybdenum oxide as the metal catalyst, and a ZrO₂ carrier; a system comprising Pt and at least one selected from molybdenum and molybdenum oxide as the metal catalyst, and a YSZ carrier; a system comprising Pt and at least one selected from molybdenum and molybdenum oxide as the metal catalyst, and an Al₂O₃ carrier; or a system comprising Pt, at least one selected from molybdenum, and molybdenum oxide, and K as the metal catalyst, and a TiO₂ carrier.

In particular, the catalyst for fuel reforming according to aspects of the present invention may be a system comprising Pt and molybdenum oxide as the metal catalyst and a TiO₂ carrier (Pt-molybdenum oxide/TiO₂); a system comprising Pt and molybdenum oxide as the metal catalyst and a ZrO₂ carrier (Pt-molybdenum oxide/ZrO₂); a system comprising Pt and molybdenum oxide as the metal catalyst and a YSZ carrier (Pt-molybdenum oxideNSZ); a system comprising Pt and molybdenum oxide as the metal catalyst and an Al₂O₃ carrier (Pt-molybdenum oxide/Al₂O₃); or a system comprising Pt, molybdenum oxide, and K as the metal catalyst and a TiO₂ carrier (Pt-molybdenum oxide-K/TiO₂).

When the liquid phase reforming reaction of a fuel, such as methanol, is performed according to Reaction Scheme 1, as shown below, using the catalyst for fuel reforming as described above at a low temperature of 400° C. or less, and preferably about 60-250° C., high concentration hydrogen can be produced without using a water-gas shift reactor to remove CO. No further water-gas shift reactor is needed as a dehydrogenation reaction shown below in Reaction Scheme 2 of methanol occurs in a temperature range of a thermodynamic conversion of CO shown below in Reaction Scheme 3 through a water-gas shift reaction.

CH₃OH+H₂0→CO₂+3H₂ Reaction Scheme 1

CH₃OH CO+2H₂ Reaction Scheme 2

CO+H₂0→CO₂+3H₂ Reaction Scheme 3

As such, if the methanol fuel is dehydrogenated so as to produce CO and H₂, the CO is consumed by the reaction according to Reaction Scheme 3, which occurs in the same temperature range as Reaction Schemes 1 and 2. Therefore, no additional operation or reactor is necessary to remove the produced CO from the resultant H₂ before the H₂ is supplied to the fuel cell.

In the catalyst for fuel reformation according to aspects of the present invention, the active components can be impregnated in the carrier using various methods such as deposition precipitation, coprecipitation, impregnation, sputtering, gas-phase grafting, liquid-phase grafting, incipient-wetness impregnation, and the like.

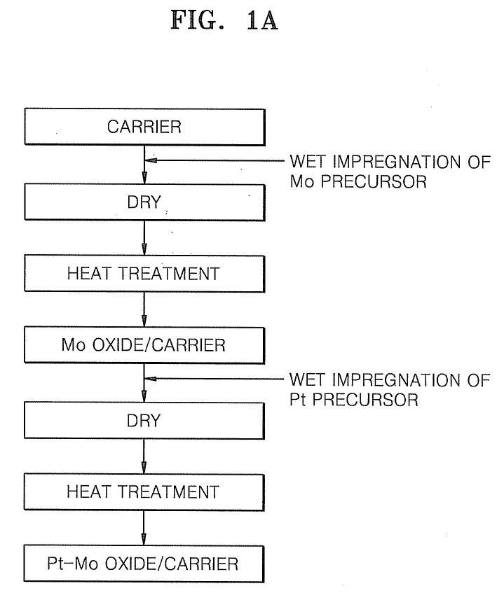

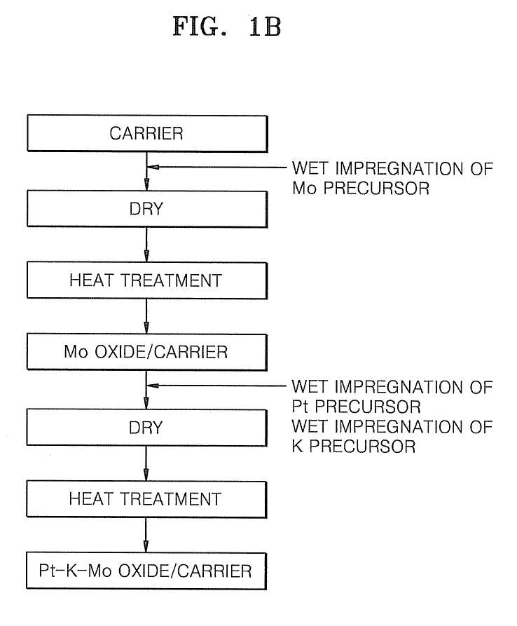

A method of preparing a catalyst for fuel reforming according to an example embodiment of the present invention will now be described with reference to the accompanying drawings. FIG. 1A is a flowchart illustrating a method of preparing a catalyst for fuel reforming comprising Pt and Mo, and a carrier according to an example embodiment of the present invention. First, an Mo precursor is wet impregnated in a catalyst carrier, such as titania. The resultant is then dried and heat-treated to obtain a catalyst comprising Mo oxide/carrier.

The Mo precursor can be ammonium molybdate, molybdenum chloride, molybdenum acetate, or the like. In the wet impregnation process of the Mo precursor, a solvent used can be distilled water. The amount of the solvent may be 10-5,000 parts by weight based on 1 part by weight of the Mo precursor.

The drying process may be performed at 60-100° C., and the heat-treatment process may be performed at 300-700° C. When the temperature of the heat-treatment process is less than 300° C., the active component B, such as Mo or the like, is insufficiently sintered. When the temperature of the heat-treatment process is greater than 700° C., the sintering process is performed at a higher temperature than required.

The catalyst comprising Mo oxide/carrier is then wet impregnated with a Pt precursor. The resultant is then dried and heat-treated to obtain a catalyst comprising Pt—Mo oxide/carrier. The Pt precursor can be potassium tetrachloroplatinate (K₂PtCl₄), tetraamine platinum nitrate (Pt(NO₃)₂(NH₄)₄), chloro-platinic acid (H₂PtCl₆), platinum chloride (PtCl₂), or the like. In the wet impregnation process of Pt precursor, a solvent used can be distilled water. The amount of the solvent may be 10-5,000 parts by weight based on 1 part by weight of the Pt precursor.

The drying process may be performed at 60-100° C., and the heat-treatment process may be performed at 200-600° C. When the temperature of the heat-treatment process is less than 200° C., the active catalyst components are insufficiently sintered. When the temperature of the heat-treatment process is greater than 600° C., the sintering process is performed at a higher temperature than required.

In the heat-treatment process, the catalyst comprising Pt—Mo oxide/carrier can exist as Mo oxide alone, partially reduced Mo oxide, Mo, or a mixture thereof.

FIG. 1B is a flowchart illustrating a method of preparing a catalyst for fuel reforming comprising Pt, Mo oxide, and K and a carrier according to an example embodiment of the present invention. The method of preparing a catalyst comprising Mo oxide/carrier is the same as illustrated in FIG. 1A, i.e., the operations of FIG. 1A that result in the Mo oxide/carrier are the same as the operations of FIG. 1B to produce the Mo oxide/carrier.

Referring to FIG. 1B, the catalyst comprising Mo oxide/carrier is wet impregnated with a Pt precursor and a K precursor. The resultant is then dried and heat-treated to obtain a Pt—Mo oxide-K/carrier catalyst. The K precursor can be KCl, K₂CO₃, KOH, or the like. In the wet impregnation process of the Pt precursor and the K precursor, a solvent used can be distilled water. The amount of the solvent may be 10-5,000 parts by weight based on 1 part by weight of the Pt precursor. The heat-treatment process may be performed at 200-600° C. as in the case of preparing a catalyst comprising Pt—Mo oxide/carrier.

In the method of preparing a catalyst for fuel reforming according to the current example embodiment of the present invention, the amount of the Pt precursor, the Mo precursor, and the K precursor used to produce the metal catalyst according to aspects of the present invention can be an amount that satisfies the mixing ratio of the active component A, the active component B, and the active component C as described above.

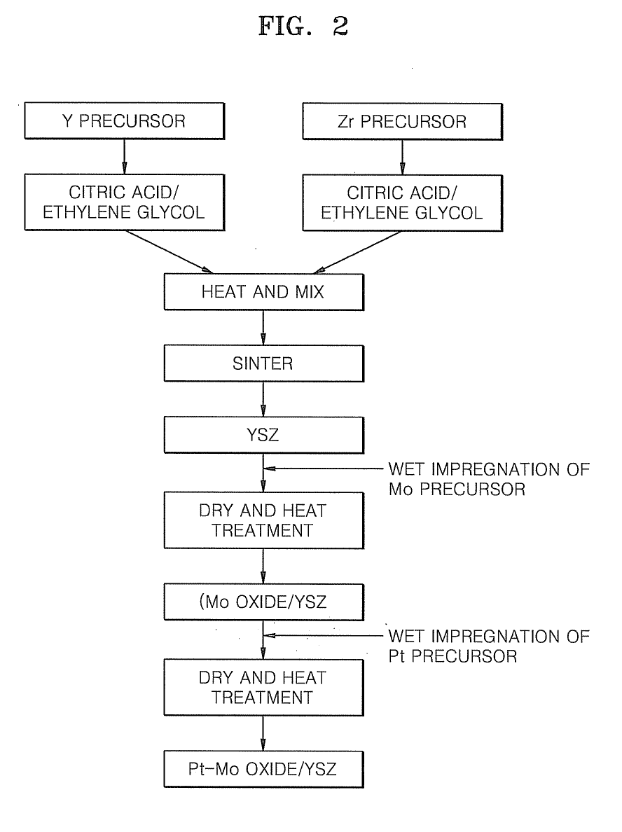

FIG. 2 is a flowchart illustrating a method of preparing yttria stabilized zirconia (YSZ) having a high surface area, which is used as a carrier, and then preparing a catalyst comprising Pt—Mo oxide/YSZ according to an example embodiment of the present invention using the same. Referring to FIG. 2, first, a Y precursor is mixed with an acid and a solvent to obtain a mixture A. Separately, a Zr precursor is mixed with an acid and a solvent to obtain a mixture B. The Y precursor can be Y(NO₃)₃.6H₂O, or the like, and the Zr precursor can be ZrO(NO₃)₂, or the like.

The acid used in the preparation of the mixture A and the mixture B can be a citric acid, an acetic acid, a propionic acid, or the like. The solvent can be ethylene glycol, methanol, ethanol, propanol, butanol, pentanol, hexanol, or the like. The amount of the acid may be 2-20 parts by weight based on 1 part by weight of the Y precursor or the Zr precursor, respectively. The amount of the solvent may be 10-80 parts by weight based on 1 part by weight of the Y precursor or the Zr precursor, respectively.

The mixture A and the mixture B are then mixed, heated, and sintered to obtain yttria-stabilized zirconia (YSZ). The obtained YSZ has a surface area in the range of 20-1,500 m²/g and has an excellent capability of being impregnated with catalysts. The heating process may be performed at a temperature of 150-300° C. The sintering process may be performed at a temperature of 400-600° C., and preferably at a temperature of about 500° C. for 4 hours.

The YSZ obtained by the processes as described above is then wet impregnated with an Mo precursor under the same conditions as those illustrated in FIG. 1. The resultant is then dried and heat-treated to obtain Mo oxide/YSZ. Subsequently, the Mo oxide/YSZ is wet impregnated with a Pt precursor according to the conditions as described above. The resultant is then dried and heat-treated to obtain a catalyst comprising Pt—Mo oxide/YSZ.

Hereinafter, a method of producing hydrogen using the catalyst for fuel reforming according to aspects of the present invention and a fuel processor according to aspects of the present invention, comprising the catalyst for fuel reforming, will be described. A reformer comprising the catalyst for fuel reforming according to aspects of the present invention is manufactured. A reforming reaction of a fuel gas is then performed at a low temperature, specifically 60-250° C., using a fuel processor including the reformer. As a result, hydrogen, which is a desired fuel gas, can be produced without additionally using a water-gas shift reactor required to remove CO.

The fuel gas may be oxygenated hydrocarbon such as methanol, ethanol, propanol, ethylene glycol, formaldehyde, methyl formate, formic acid, or a mixture thereof, and preferably methanol. Methanol is a liquid fuel that can be conveniently and easily stored, used, obtained, and has low environmental impact. In addition, the optimum thermodynamic temperature of a gas phase reforming reaction of methanol, which is in the range of 200-300° C., is the same as the optimum thermodynamic temperature of the water-gas shift (WGS) reaction as described above with reference to Reaction Scheme 3. Therefore, hydrogen with a high purity that contains little CO can be produced using a reformer alone without additionally using a WGS reactor and a PROX reactor. Furthermore, the configuration of the reactor is simple, and energy requirements and heat loss are decreased because of the low temperature of reaction and the operating time of the reactor can be reduced.

The fuel can further comprise a salt of an alkali metal or a salt of an alkaline earth metal. The salt of the alkali metal or the salt of the alkaline earth metal can be at least one selected from the group consisting of potassium chloride, potassium carbonate, potassium hydroxide, sodium chloride, sodium carbonate, sodium hydroxide, calcium chloride, and calcium carbonate. The amount of the salt of the alkali metal or the salt of the alkaline earth metal may be 0.5-20 parts by weight based on 100 parts by weight of the total weight of the salt of the alkali metal or the salt of the alkaline earth metal and the fuel.

When a K precursor such as potassium chloride, potassium carbonate, or the like, is added to the fuel, a ternary metal catalyst containing K as an active component C is produced.

The application temperature of a liquid phase reforming reaction may be 400° C. or less, and preferably 60-250° C. The pressure conditions of the liquid phase reforming reaction may be in the range of a pressure greater than that which can maintain the liquid phase of reactants under each temperature condition.

Aspects of the present invention will now be described in greater detail with reference to the following Examples and Comparative Examples. The following examples are for illustrative purposes only and are not intended to limit the scope of the invention.

### Example 1

An aqueous solution, in which 1.37 g of (NH₄)₆Mo₇O₂₄.4H₂O, as an Mo precursor, was dissolved in 100 ml of water, was added to 10 g of a TiO₂ powder. The mixture was then stirred at 60° C. for 10 hours. The resultant was dried using a rotary evaporator at 60° C. and then dried under an air atmosphere at 110° C. for 4 hours. The resultant was heat treated under an air atmosphere at 400° C. for 4 hours to obtain a catalyst in which Mo oxide was impregnated in a titania carrier.

An aqueous precursor solution, in which 1.05 g of Pt(NH₃)₄(NO₃)₂, as a Pt precursor, was dissolved in 100 ml of water, was added to the obtained catalyst. The mixture was stirred at 60 C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt—Mo oxide/TiO₂.

By performing a methanol reforming reaction using the prepared catalyst, the hydrogen production rate and the composition of the product were determined. The methanol reforming reaction was performed by adding 40 g of fuel, the fuel comprising methanol and water mixed in a weight ratio of 1:4, and 0.5 g of the catalyst to a reactor, the reactor having a total volume of 60 cm³. The reactor was sealed and the temperature was increased to 150° C. or 190° C. and a change in pressure was observed over time. The total volume of the product was calculated on the basis of the change in pressure that was obtained by performing the methanol reforming reaction for 2 hours at 150° C. or 190° C. In addition, the amount of the hydrogen produced per unit time was measured by multiplying the ratio of hydrogen of the product and the total amount of the product, wherein the ratio was determined through a gas analysis. The amount of CO in the product was not detected using a gas analyzer, and it was proved that the amount of CO in the product was 0.5 mol % or less, according to the error associated with the CO analysis ability of the gas analyzer.

### Example 2

A catalyst comprising Pt—Mo oxideNSZ was prepared in the same manner as in Example 1, except that 10 g of YSZ powder was used instead of 10 g of TiO₂ powder, and the hydrogen production rate was obtained by a reforming reaction.

### Example 3

A catalyst comprising Pt—Mo oxide/TiO₂ was prepared in the same manner as in Example 1, except that the amounts of a Pt precursor and an Mo precursor used were 1.6 g and 6.6 g, respectively, and the hydrogen production rate was obtained by a reforming reaction.

### Example 4

1.98 g of Y(NO₃)₃.6H₂O was dissolved in a mixed solution of 10.88 g of citric acid and 12.86 g of ethylene glycol to obtain a first mixture, and 12.11 g of ZrO(NO₃)₂ was added to a mixed solution of 110.05 g of citric acid and 130.03 g of ethylene glycol to obtain a second mixture. The first and second mixtures were combined to obtain a working mixture. The working mixture was stirred at 100° C. for 2 hours and heated at 200° C. for 5 hours, respectively. The working mixture was sintered under an air atmosphere at 500° C. for 4 hours to obtain a YSZ carrier.

An aqueous solution, in which 1.37 g of (NH₄)₆Mo₇O₂₄.4H₂O, as an Mo precursor, was dissolved in 100 ml of water, was added to 10 g of YSZ complex oxide. The mixture was stirred at 60° C. for 10 hours. The resultant was dried using a rotary evaporator at 60° C. and then dried under an air atmosphere at 110° C. for 4 hours. The resultant was then heat treated under an air atmosphere at 400° C. for 4 hours to obtain a catalyst comprising Mo oxide/YSZ.

An aqueous precursor solution, in which 1.05 g of Pt(NH₃)₄(NO₃)₂, as a Pt precursor, was dissolved in 100 ml of water, was added to the Mo oxide/YSZ catalyst. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt—Mo oxide/YSZ. The hydrogen production rate in a reforming reaction was obtained in the same manner as that of Example 1.

### Example 5

An aqueous solution, in which 1.37 g of (NH₄)₆Mo₇O₂₄.4H₂O, as an Mo precursor, was dissolved in 100 ml of water, was added to 10 g of TiO₂ powder. The mixture was then stirred at 60° C. for 10 hours. The resultant was dried using a rotary evaporator at 60° C. and then dried under an air atmosphere at 110° C. for 4 hours. The resultant was heat treated under an air atmosphere at 400° C. for 4 hours to obtain a catalyst in which Mo oxide was impregnated in a titania carrier.

An aqueous precursor solution, in which 1.40 g of H₂PtCl₆ and 0.40 g of K₂CO₃, as a Pt precursor and a K precursor were dissolved in 100 ml of water, was added to the catalyst. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt—Mo oxide-K/TiO₂. The hydrogen production rate in a reforming reaction was obtained in the same manner as that of Example 1.

### Example 6

A catalyst comprising Pt—Mo oxide-K/Al₂O₃ was prepared in the same manner as in Example 5, except that the amount of the K precursor was 0.80 g. The hydrogen production rate in a reforming reaction was obtained in the same manner as that of Example 1.

### Example 7

An aqueous solution, in which 1.37 g of (NH₄)₆Mo₇O₂₄.4H₂O, as an Mo precursor, was dissolved in 100 ml of water, was added to 10 g of TiO₂ powder. The mixture was then stirred at 60° C. for 10 hours. The resultant was dried using a rotary evaporator at 60° C. and then dried under an air atmosphere at 110° C. for 4 hours. The resultant was heat treated under an air atmosphere at 400° C. for 4 hours to obtain a catalyst in which Mo oxide was impregnated in a titania carrier.

An aqueous precursor solution, in which 1.40 g of H₂PtCl₆ was dissolved in 100 ml of water, was added to the catalyst. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt—Mo oxide/TiO₂. By performing a methanol reforming reaction using the prepared catalyst, the hydrogen production rate and the composition of the product were determined. The methanol reforming reaction was performed by dissolving 0.02 g of K₂CO₃ in 40 g of fuel, the fuel comprising methanol and water mixed in a weight ratio of 1:4. Then 0.5 g of the catalyst was added to the mixture, and the resulting product was placed in a reactor, the reactor having a total volume of 60 cm³. The reactor was then sealed and the temperature of the reactor was increased to 150° C. or 190° C. and a change in pressure over time was observed. The total volume of the product was calculated on the basis of the change in pressure that was obtained by performing the methanol reforming reaction for 2 hours at 150° C. or 190° C. In addition, the amount of the hydrogen produced per unit time was calculated by multiplying the ratio of hydrogen of the product and the total amount of the produced product, wherein the ratio was determined through a gas analysis.

### Comparative Example 1

A commercial Pt catalyst in which 0.3 wt % of Pt was impregnated in an Al₂O₃ carrier was used. The hydrogen production rate in a reforming reaction was obtained in the same manner as that of Example 1.

### Comparative Example 2

A commercial Cu catalyst in which Cu was impregnated in an Al₂O₃ carrier with 30 wt % or more was used. The hydrogen production rate in a reforming reaction was obtained in the same manner as that of Example 1.

### Comparative Example 3

An aqueous solution, in which 0.2 g of Pt(NH₃)₄(NO₃)₂, as a Pt precursor, was dissolved in 100 ml of water, was added to 10 g of Al₂O₃ powder. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt/Al₂O₃. The hydrogen production rate in a reforming reaction was obtained in the same manner as that of Example 1.

### Comparative Example 4

A catalyst comprising Pt/Al₂O₃ was prepared in the same manner as in Comparative Example 3, except that the amount of the Pt precursor was 1.05 g. The hydrogen production rate in a reforming reaction was obtained in the same manner as that of Example 1.

### Comparative Example 5

An aqueous solution, in which 1.05 g of Pt(NH₃)₄(NO₃)₂, which was a Pt precursor, was dissolved in 100 ml of water, was added to 10 g of TiO₂ powder. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt/TiO₂. The hydrogen production rate in a reforming reaction was obtained in the same manner as that of Example 1.

### Comparative Example 6

An aqueous solution, in which 0.53 g of Ni(NO₃)₂.6H₂O and 1.13 g of Pt(NH₃)₄(NO₃)₂, as a Ni precursor and a Pt precursor, respectively, were dissolved in 100 ml of water, was added to 10 g of TiO₂ powder. The mixture was stirred at 60° C. for 10 hours. The resultant was dried using a rotary evaporator at 60° C. and then dried under an air atmosphere at 110° C. for 4 hours. The resultant was then heat treated under an air atmosphere at 300° C. for 4 hours to obtain a catalyst comprising Pt—Ni/TiO₂. The hydrogen production rate in a reforming reaction was obtained in the same manner as that of Example 1.

TABLE 1

| | | | | | | Reaction | Reaction |
|---|---|---|---|---|---|---|---|
| | | | | | | Temperature: | Temperature: |
| | | Composition | | | | 150° C. | 190° C. |
| | | Active | Active | Active | | H₂ production rates | H₂ production rates |
| | Catalyst Name | Component A | Component B | Component C | Carrier | (μmol gcat⁻¹ h⁻¹) | (μmol gcat⁻¹ h⁻¹) |
| Example 1 | 5Pt-6.6MO/TiO₂ | 5 wt % | 6.6 wt % | N/A | TiO₂ | 2240 | 3930 |
| | | Pt | MO | | | | |
| Example 2 | 5Pt-6.6MO/YSZ | 5 wt % | 6.6 wt % | N/A | YSZ | 1080 | 3760 |
| | | Pt | MO | | | | |
| Example 3 | 7Pt-30MO/TiO₂ | 7 wt % | 30 wt % | N/A | TiO₂ | 1880 | N/A |
| | | Pt | MO | | | | |
| Example 4 | 5Pt-6.6MO/ | 5 wt % | 6.6 wt % | N/A | YSZ(P) | 2200 | 3930 |
| | YSZ(P) | Pt | MO | | | | |
| Example 5 | 5Pt-6.6MO-2K/ | 5 wt % | 6.6 wt % | 2 wt % K | TiO₂ | 2600 | 5400 |
| | TiO₂ | Pt | MO | | | | |
| Example 6 | 5Pt-6.6MO-4K/ | 5 wt % | 6.6 wt % | 4 wt % K | TiO₂ | 2600 | 6450 |
| | TiO₂ | Pt | MO | | | | |
| Example 7 | 5Pt-6.6MO/TiO₂ | 5 wt % | 6.6 wt % | 4 wt % K | TiO₂ | 2200 | 4650 |
| | | Pt | MO | (fuel) | | | |

In Table 1, MO is short for Mo oxide.

TABLE 2

| | | | | | | Reaction | Reaction |
|---|---|---|---|---|---|---|---|
| | | | | | | Temperature: | Temperature: |
| | | Composition | | | | 150° C. | 190° C. |
| | Catalyst | Active | Active | Active | | H₂ production rates | H₂ production rates |
| | Name | Component A | Component B | Component C | Carrier | (μmol gcat−1 h−1) | (μmol gcat−1 h−1) |
| Comparative | Commercial | 0.3 wt % | N/A | N/A | Al₂O₃ | 220 | 410 |
| Example 1 | Catalyst | Pt | | | | | |
| Comparative | Commercial | >30 wt % | Zn | N/A | Al₂O₃ | 180 | N/A |
| Example 2 | Catalyst | Cu | | | | | |
| Comparative | 1Pt/Al₂O₃ | 1 wt % | N/A | N/A | Al₂O₃ | 130 | 1930 |
| Example 3 | | Pt | | | | | |
| Comparative | 5Pt/Al₂O₃ | 5 wt % | N/A | N/A | Al₂O₃ | 130 | 1590 |
| Example 4 | | Pt | | | | | |
| Comparative | 5Pt/TiO₂ | 5 wt % | N/A | N/A | TiO₂ | 940 | 3480 |
| Example 5 | | Pt | | | | | |
| Comparative | 5Pt—1Ni/ | 5 wt % | 1 wt % | N/A | Al₂O₃ | 630 | 1720 |
| Example 6 | Al₂O₃ | Pt | Ni | | | | |

From the results shown in Tables 1 and 2, it can be seen that when catalysts prepared in Examples 1 through 7 are used, hydrogen reaction activity is excellent and is particularly improved at low temperatures. For example, Example 1 demonstrated an H₂ production rate, as measured in μmol per gcat per hour, of 2240 at a reaction temperature of 150° C. and an H₂ production rate, as measured in μmol per gcat per hour, of 3930 at a reaction temperature of 190° C. Further, Example 6 demonstrated an H₂ production rate, as measured in μmol per gcat per hour, of 2600 at a reaction temperature of 150° C. and an H₂ production rate, as measured in μmol per gcat per hour, of 6450 at a reaction temperature of 190° C. In comparison, the most active comparative example, Comparative Example 5, only demonstrated an H₂ production rate, as measured in μmol per gcat per hour, of 940 at a reaction temperature of 150° C. and an H₂ production rate, as measured in μmol per gcat per hour, of 3480 at a reaction temperature of 190° C. As demonstrated, the catalysts prepared according to aspects of the present invention produce hydrogen at a much greater rate and do so at decreased temperatures.

The catalyst for fuel reforming according to aspects of the present invention has excellent catalytic activity at a low temperature and improved hydrogen purity. Therefore, by using the catalyst for fuel reforming according to aspects of the present invention, high-purity hydrogen, which is a fuel of a fuel cell, can be produced with high purity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A catalyst for fuel reforming, comprising:
a metal catalyst that comprises
an active component A that includes at least one metal selected from the group consisting of platinum (Pt), palladium (Pd), iridium (Ir), rhodium (Rh), and ruthenium (Ru); and
an active component B that includes at least one metal selected from the group consisting of molybdenum (Mo), vanadium (V), tungsten (W), chromium (Cr), rhenium (Re), cobalt (Co), cerium (Ce) and iron (Fe), oxides thereof, alloys thereof, and mixtures thereof; and
a carrier impregnated by the metal catalyst.

2. The catalyst of claim 1, wherein the carrier is at least one selected from the group consisting of Al₂O₃, TiO₂, ZrO₂, SiO₂, YSZ, Al₂O₃—SiO₂, and CeO₂.

3. The catalyst of claim 1, wherein the metal catalyst further comprises an active component C selected from alkali metals and alkaline earth metals.

4. The catalyst of claim 3, wherein the active component C is at least one selected from the group consisting of lithium (Li), sodium (Na), potassium (K), rubidium (Rb), cesium (Cs), calcium (Ca), magnesium (Mg), and barium (Ba).

5. The catalyst of claim 4, wherein the amount of the active component C is 0.01-10 parts by weight based on 1 part by weight of the active component A.

6. The catalyst of claim 1, wherein the active component A is Pt, and the active component B is molybdenum oxide.

7. The catalyst of claim 1, wherein the active component A is Pt, the active component B is molybdenum oxide, and an active component C is K.

8. The catalyst of claim 1, wherein the amount of the active component B is 0.1-20 parts by weight based on 1 part by weight of the active component A.

9. The catalyst of claim 1, wherein the amount of the active component A is 0.1-30 parts by weight based on 100 parts by weight of the total weight of the catalyst for fuel reforming.

10. The catalyst of claim 1, wherein the amount of the carrier is 50-99 parts by weight based on 100 parts by weight of the total weight of the catalyst for fuel reforming.

11. The catalyst of claim 1, wherein the active component A is Pt, the active component B is molybdenum oxide, and the carrier is TiO₂.

12. A method of producing hydrogen, comprising:
using a fuel reforming reaction performed by reacting a fuel with a catalyst, the catalyst being the catalyst for fuel reforming of claim 1.

13. The method of claim 12, wherein the fuel reforming reaction is performed at a temperature of 60-250° C.

14. The method of claim 12, wherein the fuel is at least one selected from the group consisting of methanol, ethanol, propanol, ethylene glycol, formaldehyde, methyl formate, and formic acid.

15. The method of claim 12, wherein the fuel further comprises a salt of an alkali metal or a salt of an alkaline earth metal.

16. The method of claim 15, wherein the salt of the alkali metal or the salt of the alkaline earth metal is at least one selected from the group consisting of potassium chloride, potassium carbonate, potassium hydroxide, sodium chloride, sodium carbonate, sodium hydroxide, calcium chloride, and calcium carbonate.

17. The catalyst of claim 1, wherein the active component A is Pt, the active component B is molybdenum oxide, and the carrier is ZrO₂.

18. The catalyst of claim 1, wherein the active component A is Pt, the active component B is molybdenum oxide, and the carrier is YSZ.

19. The catalyst of claim 1, wherein the active component A is Pt, the active component B is molybdenum oxide, and the carrier is Al₂O₃ carrier.

20. The catalyst of claim 3, wherein the active component A is Pt, the active component B is molybdenum, the active component C is K, and the carrier is TiO₂.

21. A catalyst of producing hydrogen from a fuel, comprising:
a metal catalyst comprising:
an active component A, the active component A being a transition metal having a Pauling electronegativity of 2.20 to 2.28; and
an active component B, the active component B being a transition metal, a lanthanide, or an actinide having a Pauling electronegativity less than the Pauling electronegativity of the active component A, or oxides, alloys, and mixtures thereof; and
a carrier impregnated by the metal catalyst.

22. The catalyst of claim 21, further comprising:
an active component C, the active component C being an alkali metal or an alkaline earth metal.

23. A method for producing hydrogen, comprising:
providing a fuel to a reformer comprising a metal catalyst;
wherein the reformer operates at a temperature between 60 and 250° C. to produce hydrogen having less than 0.5 mol % of CO.

24. The method of claim 23, wherein the metal catalyst comprises:
an active component A that includes at least one metal selected from the group consisting of platinum (Pt), palladium (Pd), iridium (Ir), rhodium (Rh), and ruthenium (Ru); and
an active component B that includes at least one metal selected from the group consisting of molybdenum (Mo), vanadium (V), tungsten (W), chromium (Cr), rhenium (Re), cobalt (Co), cerium (Ce) and iron (Fe), oxides thereof, alloys thereof, and mixtures thereof,
wherein the metal catalyst is impregnated in a metal oxide carrier.

25. The method of claim 23, wherein the metal catalyst comprises:
an active component A, the active component A being a transition metal having a Pauling electronegativity of 2.20 to 2.28; and
an active component B, the active component B being a transition metal, a lanthanide, or an actinide having a Pauling electronegativity less than the Pauling electronegativity of the active component A, or oxides, alloys, and mixtures thereof,
wherein the metal catalyst is impregnated in a metal oxide carrier.
